(19) United States
(12) Patent Application Publication
(10) Pub. No.: US 2006/0237361 A1
(43) Pub. Date: Oct. 26, 2006

(54) Ceramic nanofiltration membrane for use in organic solvents and method for the production thereof

(75) Inventors: Gregor Dudziak, Koln (DE); Thomas Hoyer, Bad Berka (DE); Andreas Nickel, Wetter (DE); Petra Puhlfuerss, Buergel (DE); Ingolf Voigt, Jena (DE)

Correspondence Address: NORRIS, MCLAUGHLIN & MARCUS, P.A., 875 THIRD AVE, 18TH FLOOR, NEW YORK, NY, 10022, US

(73) Assignee: Bayer Technology Services GmbH, Leverkusen (DE)

(21) Appl. No.: 10/547,063

(22) PCT Filed: Feb. 25, 2004
(86) PCT No.: PCT/EP04/01831

§ 371 Date: Jan. 24, 2006

(30) Foreign Application Priority Data
Feb. 26, 2003 (DE) 103 08 110.0

(51) Int. Cl. B01D 71/00

(52) U.S. Cl. 210/500.21; 210/500.25; 210/644; 501/1

(57) ABSTRACT

Ceramic nanofiltration membrane for use with organic solvents is produced by impregnating a mesoporous ceramic membrane with a hydrophobing agent.

The invention concerns a ceramic nanofiltration membrane for use in organic solvents, as well as a method for its production.

Ceramic filter elements generally have an asymmetric structure in which thin membrane layers with one or more intermediate layers are applied to a porous ceramic support. Different membrane filtration ranges, like microfiltration, ultrafiltration and nanofiltration are distinguished according to the pore size or retention capacity.

The porous ceramic support stipulates the external shape and mechanical stability of the filter element. Common variants are disks, which are produced by film casting or pressing, and tubes, which are extruded in most cases as rigid plastics. After the sintering process, which can lie between 1200 and 1700° C., depending on the employed ceramic material, an open-pore ceramic body is obtained. The pores are formed by cavities between the sintered grains (intermediate grain pores). Pore sizes between 1 μm and 10 μm can be set, depending on the employed initial particle size and particle shape.

Ceramic microfiltration membranes in most cases are produced using narrowly classified ceramic powders. These powders are dispersed in an appropriate solvent, using auxiliaries (dispersants). The slurry so produced is mixed with solutions of organic binders and then used to coat the porous ceramic support. In contact with the porous support the solvent penetrates into the support, forming a thin ceramic layer on the surface. This is dried and then fired at high temperature between 800 and 1400° C., depending on the employed fineness of the powder (A. Burggraaf, K. Keizer, in Inorganic Membranes, ed. R. R. Bhave, Van Nostrand Reinhold, New York, p. 10-63). Increasingly more fine-pored membranes can be produced with increasingly finer ceramic powders in this way. The finest available powders have a particle size of about 60-100 nm, from which membranes with a pore size of about 30 nm can be produced. This is the upper range of ultrafiltration.

Ceramic ultrafiltration membranes with a lower separation limit can be produced via the sol-gel technique in aqueous solution. For this purpose, metal alcoholates are preferably fully hydrolyzed in water. Colloidal hydroxide and hydrated oxide particles are formed, which can be stabilized by adding small amounts of electrolyte (mineral acid or alkali). Solutions of organic binders are added to these so-called sols and the solution so formed used for coating. Ceramic microfiltration membranes or coarse ultrafiltration membranes are used as supports. The solvent of the sol penetrates into the porous support. The concentration increase on the surface leads to a sharp rise in viscosity and formation of a gel. This gel is then carefully dried and finally fired at temperatures between 400 and 1000° C. In this way ceramic membranes can be produced for the lower range of ultrafiltration with slit-like pores and a pore diameter between 3 nm and 10 nm (I. Voigt, G. Mitreuter, M. Füting, CfI/Ber. DKG 79 (2002), E39-E44).

Ceramic membranes for nanofiltration can be produced via a special form of the sol-gel technique. For this purpose an organic solvent is used instead of water and hydrolysis is carried out only with a defined amount of water, which is substoichiometric relative to the number of hydrolyzable alcoholate groups. At the same time, the formed hydroxide groups begin to condense with water cleavage. The oligomers so produced are inhibited from further chain growth with increasing chain length and the state of a sol is also formed, which is also referred to in this special case as a polymer sol (C. J. Brinker, G. W. Scherer, Sol-Gel Science, Academic Press, Inc., 1990). Because of strong dilution of the sol this state can be stabilized for several days. Addition of binders is not required owing to the polymer structure of the sol. The principle of layer formation is again comparable to that in ceramic slurries and particulate salts. The solution penetrates into the pores, the viscosity of the surface layer increases, a gel is formed. This is dried and then fired at temperatures between 200 and 600° C. In this way cylindrical pores with an average pore diameter of less than 2 nm are obtained. Voight et al. (Proc. of 5^{th} Inter. Conf. on Inorg. Membr. (5^{th} ICIM), Jul. 22-26, 1998, Nagoya, Japan, pp. 42-45) produced in this way TiO₂ nanofiltration membranes with an average pore diameter of 0.9 nm, a water flow rate of 20 L/(m²·h·bar) and a molecular separation limit (90% retention) in aqueous solution at 450 g/mol (J. Membr. Sci. 174 (2000), 123-133).

WO98/17378 describes an inorganic nanofiltration membrane consisting of sintered metal oxide particles in a graded layer sequence on a monolithic, ceramic, multichannel support. It carries on the channel walls a microfiltration layer, this has an ultrafiltration layer and this finally a nanofiltration layer, whose equivalent pore diameter before sintering lies in the range between 0.5 nm and 1.5 nm and has a separation edge between 100 and 2000 dalton. The nanofiltration membrane preferably consists of zirconium oxide and is preferably produced in the sol-gel method by hydrolysis in an alcoholic media. The area of application is processing of salt solutions (for example NaCl solutions) during regeneration of ion exchange resins, which are used in refining of sugar cane. Aqueous solutions are therefore involved here, not organic solvents.

Depending on the pore size, a distinction is made between macropores with a pore size >100 nm, mesopores with a pore size between 100 nm and 2 nm and micropores with a pore size less than 2 nm. Ceramic ultrafiltration membranes therefore preferably have mesopores, ceramic nanofiltration membranes and micropores.

If one investigates the described nanofiltration membranes with respect to their separation behavior in organic solvents, one surprisingly finds that the flow rate in comparison with water drops sharply. A flow rate <5 L/(m²·h·bar) is measured in the TiO₂ membranes with a pore size of 0.9 nm. Separation limit increases at the same time to >2000 g/mol.

In order to obtain ceramic nanofiltration membranes for use in organic solvents, an attempt was made to improve the flow rate of the organic solvent through the membrane pores, using mixed oxides.

Guizard et al. (Desalination 147 (2002), 275-280) investigated the mixed oxides SiO₂/TiO₂, Al₂O₃/ZrO₂ and SiO₂/ZrO₂. They obtained microporous ceramic membranes with pore radii ≦1 nm with scarcely improved permeation behavior.

Tsuru et al. (J. Coll. Interf. Sci. 228 (2000), 292-296; J. Membr. Sci. 185 (2001), 253-261) investigated the behavior of SiO₂/ZrO₂ membranes produced via a sol-gel process. They varied the pore size between 1 nm and 5 nm. This did not lead to a flow rate as obtained in aqueous solvents either.

Our own studies showed that the reason for this behavior lies in the strong hydrophilicity of the ceramic micropores, which is caused by the fact that water or OH groups are added to the oxide surface. These micropores are not permeable to organic solvent molecules. Transport occurs through larger pores and/or defects, which only have a limited fraction of the total pore volume. Because of this the flow rate drops in comparison with water flow. The retention of these larger pores or defects lies well above that of the micropores.

If the micropores are configured hydrophobic, permeation of water should be inhibited and possibly completely restricted. The flow rate of organic solvents is surprisingly improved and the retention of molecules dissolved in organic solvents is not improved relative to hydrophilic NF membrane.

WO92/06775 claims a nanofiltration membrane in which a support consisting of an inorganic substance is coated with a first layer with a porous inorganic material with a pore radius lower than 10 nm and contains a second active layer with a thickness of 0.1 μm to 1 μm, which consists of an organic polymer.

WO99/61140 describes a method for production of hydrophobic inorganic membranes by a sol-gel process, in which alcoholates with at least one nonhydrolyzable hydrocarbon group are used. These are added to the hydrolysis process after hydrolysis of the pure alcoholates has progressed to a certain point. As an example of alcoholates with nonhydrolyzable hydrocarbon groups, methyltriethoxysilane is described. A sol is formed that contains the hydrophobing components. As a result, microporous hydrophobic membranes with pore sizes of 0.5 nm and 0.7 nm are obtained, which can be used for gas separation.

WO99/29402 describes an inorganic filter membrane consisting of a support coated with a membrane, which contains covalently bonded organomineral or mineral titanium or zirconium groups.

The underlying task of the invention is to devise a ceramic nanofiltration membrane for use in organic solvents, as well as a method for its production, while avoiding the deficiencies and complicated procedures of the prior art.

This task is solved by the invention described in the claims.

In contrast to the prior art just outlined, according to the present invention the pores of mesoporous ceramic membranes, which are ordinarily used for ultrafiltration, are modified by subsequent treatment with a hydrophobing agent. The pore size then lies between 2 nm and 10 nm, preferably between 2 nm and 5 nm. The membrane consists of oxides of aluminum, silicon, zirconium or titanium or their mixtures. A silane with the general formula R₁R₂R₃R₄Si is preferably used as hydrophobing agent, in which between one and three, preferably one of the groups R₁—R₄ are hydrolyzable groups, like —Cl, —OCH₃ or —O—CH₂—CH₃. The remaining groups are nonhydrolyzable groups like alkyl groups, phenyl groups, which can be at least partially fluorinated to increase the hydrophobic effect. Bonding of the hydrophobing agents to the membrane surface occurs by a condensation reaction of the hydrolyzable groups with OH groups on the surface of the oxide membrane according to the following reaction equation:
Zr—OH+Cl—SiR₁R₂R₃→Zr—O—SiR₁R₂R₃+HCl

The use of a hydrophobing agent with only one hydrolyzable substituent preferably leads to a situation in which a monomolecular layer is added without the molecules of a hydrophobing agent reacting with each other.

Modification of the mesoporous ceramic membranes using the described hydrophobing agent can occur either in the liquid phase by impregnation of the membrane in a solution of the hydrophobing agent or in the gas phase by applying a vacuum or using a carrier gas.

By applying a pressure difference between the front and back side of the membrane, penetration of the hydrophobing agent can be supported. For better fixation of the hydrophobing agent, heat treatment between 100 and 400° C., preferably between 150 and 300° C can be used at the end.

The invention is further explained below on three practical examples. The accompanying drawings show:

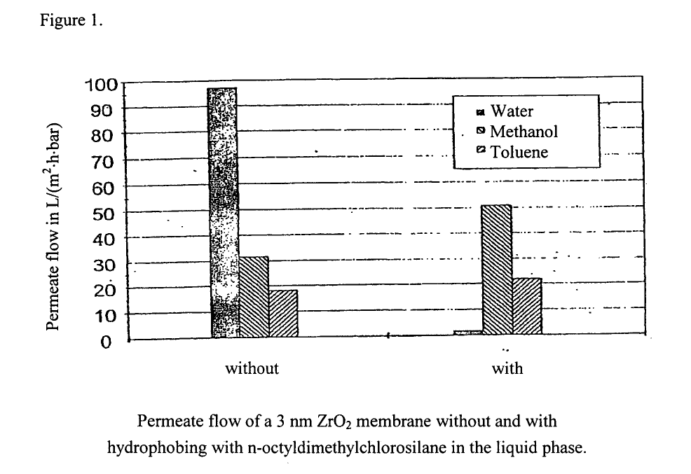

FIG. 1: Permeate flow of a 3 nm ZrO₂ membrane without and with hydrophobing with n-octyldimethylchlorosilane in the liquid phase (example 1),

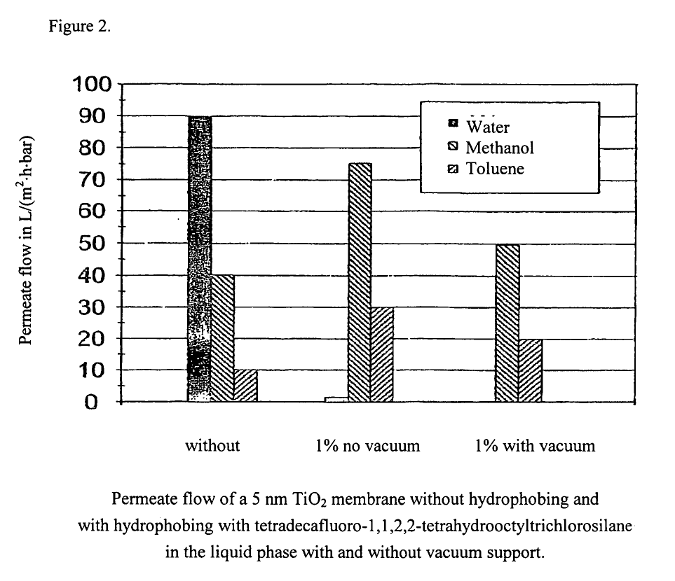

FIG. 2: Permeate flow of a 5 nm ZrO₂ membrane without and with hydrophobing with tridecafluoro-1,1,2,2-tetrahydrooctyl-trichlorosilane in the liquid phase with and without vacuum support (example 2) and

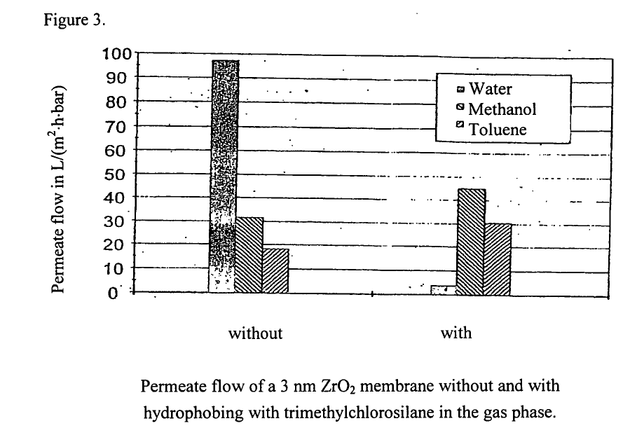

FIG. 3: Permeate flow of a 3 nm ZrO₂ membrane without and with hydrophobing with trimethylchlorosilane in the gas phase (example 3).

### EXAMPLE 1

### Hydrophobing with n-octyldimethylchlorosilane in the Liquid Phase

n-Octyldimethylchlorosilane is a molecule with a hydrolyzable group (—Cl), two nonhydrolyzable methyl groups (—CH₃) and a nonhydrolyzable octyl group (—(CH₂)₇—CH₃). 1 g of this compound is dissolved in 100 g n-heptane.

A mesoporous ZrO₂ membrane (manufacturer inocermic GmbH) with an average pore size of 3 nm is immersed in this solution. After a residence time of 2 minutes, the membrane is removed from the solution, dried in air for 10 minutes and then treated in a drying cabinet for 30 minutes at 175° C.

Hydrophobing shows up through a different wetting behavior relative to water. The untreated ZrO₂ membrane is wetted so well that a contact angle <10° is measured. After hydrophobing the surface has a contact angle of 80°.

Investigation of solid flow occurs in the crossflow method at a transmembrane pressure of 3 bar and an overflow rate of 2 m/s. Hydrophobing with n-octyldimethylchlorosilane leads to a sharp reduction in water flow from 95 L/(m²·h·bar) to 1.5 L/(m²·h·bar). In contrast to this, methanol flow rises from 32 L/(m²·h·bar) to 51 L/(m²·h·bar) and toluene flow from 18 L/(m²·h·bar) to 22 L/(m²·h·bar).

Separation limit measurements with polystyrene standards in toluene at a transmembrane pressure of 3 bar and an overflow rate of 2 m/s give a separation limit (90% retention) of 1025 g/mol for the nonhydrophobized 3 nm ZrO₂ membrane. After hydrophobing, the separation limit drops to 660 g/mol.

### EXAMPLE 2

### Hydrophobing with tridecafluoro-1 1,2,2-tetrahydrooctyltrichlorosilane in the Liquid Phase

Tridecafluoro-1,1,2,2-tetrahydrooctyltrichlorosilane is a molecule with three hydrolyzable groups (—Cl) and a long-chain, strongly fluorinated nonhydrolyzable group. 1 g of this compound is dissolved in a mixture of 50 g ethanol (99.8%) and 50 g heptane.

A mesoporous TiO₂ membrane with an average pore size of 5 nm (manufacturer inocermic GmbH) is immersed in this solution. After a residence time of 2 minutes the membrane is removed from the solution, dried in air for 10 minutes and then treated in a drying cabinet for 30 minutes at 175° C.

Hydrophobing shows up by a different wetting behavior relative to water. The untreated TiO₂ membrane is wetted so well that a contact angle <10° is measured. After hydrophobing, the surface has a contact angle of 120°.

The investigation of solvent flow occurs in the crossflow method at a transmembrane pressure of 3 bar and an overflow rate of 2 m/s. Hydrophobing with tridecafluoro-1,1,2,2-tetrahydrooctyltrichlorosilane leads to a sharp reduction of water flow from 90 L/(m²·h·bar) to 2 L/(m²·h·bar). In contrast to this the methanol flow increases from 40 L/(m²·h·bar) to 75 L/(m²·h·bar) and toluene flow from 10 L/(m²·h·bar) to 30 L/(m²·h·bar).

Separation limit measurements of polystyrene standards in toluene at a transmembrane pressure of 3 bar and an overflow rate of 2 m/s give a separation limit (90% retention) of 1800 g/mol for the nonhydrophobized 5 nm TiO₂ membrane. After hydrophobing, the separation limit drops to 1200 g/mol.

Hydrophobing can be supported by applying a vacuum to the membrane back side and drying the hydrophobing agent into the membrane pores. If a vacuum of 60 mbar is applied during hydrophobing with 1% n-octyldimethylchlorosilane solution in n-heptane, no water flow can be measured under the described experimental conditions. The methanol flow is 50 L/(m²·h·bar), toluene flow 20 L/(m²·h·bar).

### EXAMPLE 3

### Hydrophobing with trimethylchlorosilane in the Gas Phase

Trimethylchlorosilane has one hydrolyzable group (—Cl) and three methyl groups that are used for hydrophobing.

A glass dish with trimethylchlorosilane is placed on the bottom of a closable container. The weighed amount of trimethylchlorosilane is 2 g per square decimeter of surface being coated. Mesoporous ZrO₂ membranes (manufacturer inocermic GmbH) with a pore size of 3 nm are arranged in the container above the hydrophobing agent so that no contact with trimethylchlorosilane exists. The container is closed and evacuated with a membrane pump to a pressure of about 250 mbar, during which trimethylchlorosilane begins to boil at room temperature. The pump is switched off. The pressure in the container rises from the evaporating trimethylchlorosialne. After a waiting time of 10 minutes, it is evacuated again. This procedure is repeated a total of three times (at room temperature). The membranes are then tempered in air for 1 hour at 150° C.

Hydrophobing shows up by a different wetting behavior relative to water. The untreated ZrO₂ membrane is wetted so well that a contact angle of <10° is measured. After hydrophobing, the surface has a contact of 40°.

Investigation of solvent flow occurs in the crossflow method at a transmembrane pressure of 3 bar and an overflow rate of 2 m/s. Hydrophobing with trimethylchlorosilane leads to a sharp reduction of water flow from 95 L/(m²·h·bar) to 4.5 L/(m²·h·bar). In contrast to this methanol flow rises from 32 L/(m²·h·bar) to 45 L/(m²·h·bar) and toluene flow from 18 L/(m²·h·bar) to 30 L/(m²·h·bar).

Separation limit measurements for polystyrene standards in toluene at a transmembrane pressure of 3 bar and an overflow rate of 2 m/s gives a separation limit (90% retention) of 1025 g/mol for the unhydrophobized 3 nm ZrO₂ membrane. After hydrophobing, the separation limit drops to 800 g/mol.

1. Ceramic nanofiltration membrane for use in organic solvents, comprising a mesoporous ceramic membrane modified by treatment with a hydrophobing agent.

2. Ceramic nanofiltration membrane according to claim 1, wherein the mesoporous membrane has a pore size between 2 nm and 10 nm.

3. Ceramic nanofiltration membrane according to claim 1, wherein the mesoporous ceramic membrane consists of a metal oxide.

4. Ceramic nanofiltration membrane according to claim 1, wherein the hydrophobing agent used for modification is a silane of the formula R₁R₂R₃R₄Si.

5. Ceramic nanofiltration membrane according to claim 4, wherein between one and three of the groups R₁—R₄ are hydrolyzable groups.

6. Ceramic nanofiltration membrane according to claim 4, wherein between one and three of the groups R₁—R₄ are nonhydrolyzable groups.

7. Ceramic nanofiltration membrane according to claim 6, wherein at least one of the nonhydrolyzable substituents is at last partially fluorinated.

8. Method for production of the ceramic nanofiltration membrane of claim 1, which comprises modifying a mesoporous membrane by impregnating it with a hydrophobing agent in the liquid phase.

9. Method according to claim 8, wherein penetration of the hydrophobing agent is supported by a pressure difference between the front and back side of the membrane.

10. Method for production of the ceramic nanofiltration membrane of claim 1, which comprises modifying a mesoporous membrane by impregnating it with a hydrophobing agent in the gas phase.

11. Method according to claim 8 wherein, after treatment with the hydrophobing agent, heat treatment between 100 and 400° C., is applied.

12. The ceramic nanofiltration membrane of claim 2, wherein said pore size is 2 nm and 5 nm.

13. The ceramic nanofiltration membrane of claim 3, wherein said metal oxide is selected from the group consisting of TiO₂, ZrO₂, Al₂O₃, SiO₂ and mixtures of two or more thereof.

14. The ceramic nanofiltration membrane of claim 5, wherein one of the groups R₁—R₄ is a hydrolyzable group.

15. The ceramic nanofiltration membrane of claim 5, wherein said hydrolyzable groups are selected from the group consisting of Cl, —OCH₃ or —O—CH₂—CH₃.

16. The ceramic nanofiltration membrane of claim 14, wherein said hydrolyzable group is or selected from the group consisting of Cl, —OCH₃ or —O—CH₂—CH₃.

17. The ceramic nanofiltration membrane of claim 6, wherein three of the groups R₁—R₄ are nonhydrolyzable groups.

18. The ceramic nanofiltration membrane of claim 6, wherein said nonhydrolyzable groups are selected from the group consisting of alkyl groups and phenyl groups.

19. The ceramic nanofiltration membrane of claim 17, wherein said nonhydrolyzable groups are selected from the group consisting of alkyl groups and phenyl groups.

20. Method according to claim 10, wherein after treatment with the hydrophobing agent, heat treatment between 100 and 400° C. is applied.

21. Method according to claim 20, wherein said heat treatment is between 150 and 300° C.

22. Method according to claim 11, wherein said heat treatment is between 150 and 300° C.
